(19) United States
(12) Patent Application Publication
(10) Pub. No.: US 2024/0070426 A1
(43) Pub. Date: Feb. 29, 2024

(54) FLEXIBLE CARD COMMUNICATING WITH MOBILE COMMUNICATION APPARATUS

(71) Applicant: ANICA CORPORATION, New Taipei City (TW)

(72) Inventor: MENG-JEN CHENG, New Taipei City (TW)

(21) Appl. No.: 18/455,651

(22) Filed: Aug. 25, 2023

(30) Foreign Application Priority Data
Aug. 31, 2022 (TW) 111132843

(51) Int. Cl. G06K 19/07; G06K 19/02; G06K 19/077; G06Q 20/34; G06Q 20/40; H04L 9/08

(52) U.S. Cl. CPC G06K 19/0727; G06K 19/025; G06K 19/0702; G06K 19/0718; G06K 19/07707; G06Q 20/341; G06Q 20/352; G06Q 20/40145; H04L 9/0861

(57) ABSTRACT

A flexible card communicating with a mobile communication apparatus is introduced. The flexible card includes a flexible card body and a flexible electric control mechanism. Thus, mobile payment information in the mobile communication apparatus can be stored to the flexible electric control mechanism in the flexible card for a card holder to directly perform a transaction, achieving transaction security and ease of use.

### CROSS-REFERENCE TO RELATED APPLICATION

This non-provisional application claims priority under 35 U.S.C. § 119(a) on Patent Application No(s). 111132843 filed in Taiwan, R.O.C. on Aug. 31, 2022, the entire contents of which are hereby incorporated by reference.

### BACKGROUND OF THE INVENTION

### 1. Field of the Invention

The present disclosure relates to a flexible card communicating with a mobile communication apparatus, and in particular to a flexible card that communicates with a mobile communication apparatus for mobile payment transactions.

### 2. Description of the Related Art

Mobile payments over smartphones have become increasingly popular nowadays. However, to make a mobile payment over a smartphone, a consumer needs to hand the smartphone to a merchant for sensing, and such handing a personal smartphone of a user to others greatly jeopardizes transaction security and personal privacy.

Therefore, the present disclosure aims to disclose a flexible card communicating with a mobile communication apparatus, so that mobile payment information in the mobile communication apparatus can be stored to a flexible electric control mechanism in the flexible card for a card holder to directly perform a transaction and achieve transaction safety and ease of use, thereby improving the drawbacks of the prior art.

### BRIEF SUMMARY OF THE INVENTION

In view of the drawbacks of the prior art above, the applicant has dedicated to research and development to overcome these drawbacks by providing a flexible card communicating with a mobile communication apparatus, so as to store mobile payment information in the mobile communication apparatus to a flexible electric control mechanism in the flexible card for a card holder to directly perform a transaction, achieving objects of transaction security and ease of use.

To achieve the above and other objects, the present disclosure provides a flexible card communicating with a mobile communication apparatus, the flexible card including a flexible card body and a flexible electric control mechanism. The flexible electric control mechanism is disposed at the flexible card body, and includes: a storage control unit, for performing operation processing of the flexible electric control mechanism and storing fingerprint data, personal data, mobile payment information and transaction data of a user; a power unit, electrically connected to the storage control unit, the power unit for providing power; a wireless connection unit, electrically connected to the storage control unit, the power connection unit connected to a mobile communication apparatus so as to receive and store the mobile payment information to the storage control unit; a fingerprint receiving unit, electrically connected to the storage control unit, the fingerprint receiving unit receiving the fingerprint data of the user; a verification unit, electrically connected to the storage control unit, the verification unit receiving and verifying the fingerprint data from the fingerprint receiving unit; a password generating unit, electrically connected to the storage control unit, the password generating unit for generating password data to the mobile communication apparatus or a transaction apparatus; and a display unit, electrically connected to the storage control unit, the display unit for displaying a prompt during use.

In the flexible card communicating with a mobile communication apparatus, the storage control unit is a central processor, a control chip or a logic circuit.

In the flexible card communicating with a mobile communication apparatus, the power unit is a secondary battery, a primary battery or a capacitor.

In the flexible card communicating with a mobile communication apparatus, the wireless connection unit is based on a BLUETOOTH communication protocol or an NFC communication protocol.

In the flexible card communicating with a mobile communication apparatus, the display unit includes a circuit backboard, a display module, an adhesive layer and a protection outer layer. The circuit backboard has a loop groove, and the display module is disposed on one surface of the circuit backboard such that the loop groove is located on a periphery of the display module. The adhesive layer is disposed at the loop groove. The protection outer layer covers the display module.

In the flexible card communicating with a mobile communication apparatus, the display unit further includes a light emitting module, which is capable of displaying the prompt during use in coordination with the display unit.

The flexible card communicating with a mobile communication apparatus further includes an input switch. The input switch is disposed at the flexible card body and is electrically connected to the storage control unit. The input switch is a spring sheet switch, a resistive touch switch, a capacitive touch switch or a fingerprint switch.

Thus, in the flexible card communicating with a mobile communication apparatus, mobile payment information in the mobile communication apparatus can be stored to the flexible electric control mechanism in the flexible card for a card holder to directly perform a transaction, achieving objects of transaction security and ease of use.

### BRIEF DESCRIPTION OF THE DRAWINGS

FIG. 1 is a schematic diagram of an appearance according to a preferred embodiment of the present disclosure.

FIG. 2 is a section schematic diagram according to a preferred embodiment of the present disclosure.

FIG. 3 is a block schematic diagram according to a preferred embodiment of the present disclosure.

FIG. 4 is a schematic diagram of a state of use according to a preferred embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

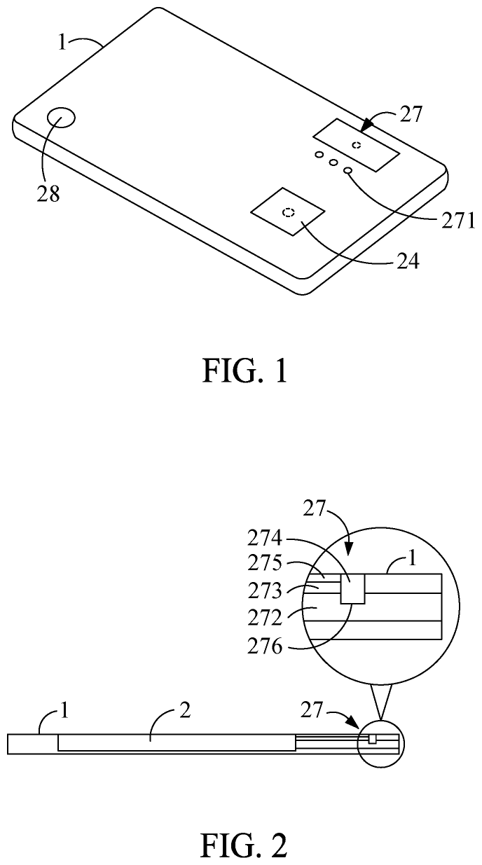

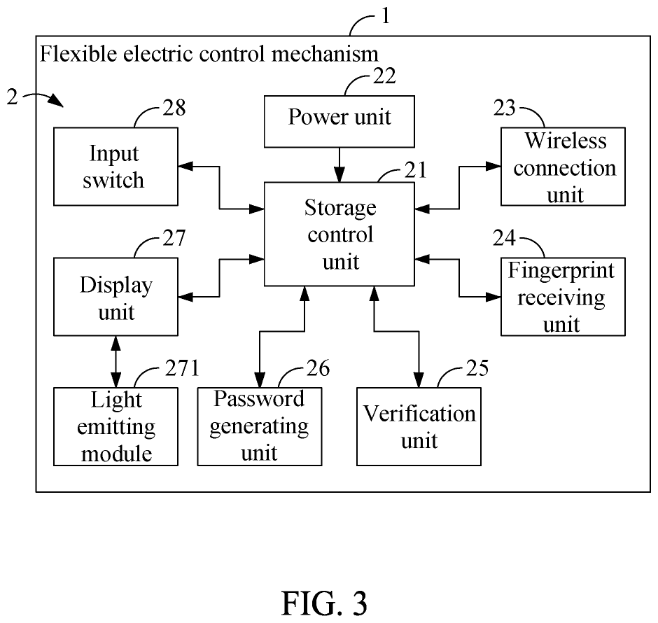

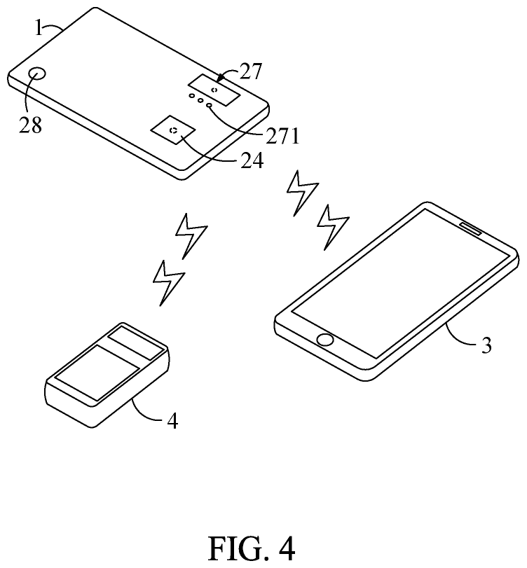

Referring to FIG. 1 to FIG. 4, as shown in the drawings, the present disclosure provides a flexible card communicating with a mobile communication apparatus, the flexible card including a flexible card body 1 and a flexible electric control mechanism 2.

The flexible card body 1 can be formed of a soft, non-metal or metal material, and at least one surface of the flexible card body 1 is provided with a pattern portion, enabling the flexible card body 1 to better meet actual requirements of use.

The flexible electric control mechanism 2 is disposed at the flexible card body 1, and includes a storage control unit 21, a power unit 22, a wireless connection unit 23, a fingerprint receiving unit 24, a verification unit 25, a password generating unit 26, and a display unit 27.

The storage control unit 21 performs operation processing for the power unit 22, the wireless connection unit 23, the fingerprint receiving unit 24, the verification unit 25, the password generating unit 26 and the display unit 27 in the flexible electric control mechanism 2, and stores fingerprint data, personal data, mobile payment information and transaction data of a user. The storage unit control 21 may be a central processor, a control chip or a logic circuit, or the wireless connection unit 23, the verification unit 25 and the password generating unit 26 may be central processors, control chips or logic circuits.

The power unit 22 is electrically connected to the storage control unit 21 and is for providing power needed for operations of storage control unit 21, the wireless connection unit 23, the fingerprint receiving unit 24, the verification unit 25, the password generating unit 26 and the display unit 27. The power unit 22 may be a secondary battery, a primary battery or a capacitor, so as to meet stable power supply during actual use.

The wireless connection unit 23 is electrically connected to the storage control unit 21 and is connected to a mobile communication apparatus 3 so as to receive the and store the mobile payment information to the storage control unit 21. The wireless connection unit 23 may be based on the BLUETOOTH communication protocol or the NFC communication protocol, so as to meet stability during actual connections in response to requirements of different connection means.

The fingerprint receiving unit 24 is electrically connected to the storage control unit 21 and receives the fingerprint data of the user. The fingerprint receiving unit 24 is a hard fingerprint receiving unit or a flexible fingerprint receiving unit, so as to adapt to different flexible card bodies 1 or requirements of use, thereby enabling the present disclosure to better meet requirements of actual use.

The verification unit 25 is electrically connected to the storage control unit 21 and receives and verifies the fingerprint data from the fingerprint receiving unit 24.

The password generating unit 26 is electrically connected to the storage control unit 21 and is for generating password data to the mobile communication apparatus 3 or a transaction apparatus 4.

The display unit 27 is electrically connected to the storage control unit 21 and is for displaying a prompt during use.

To store mobile payment information in the mobile communication apparatus 3, the card holder may contact the fingerprint receiving unit 24 by a finger (a finger with completed finger settings), so that the storage unit 21 performs recognition and verification of a fingerprint received by the fingerprint receiving unit 24. Upon confirming that the fingerprint belongs to the card holder, the display unit 27 outputs a confirmation message (for example, various light signals or text messages), and the storage control unit 21 is caused to activate the wireless connection unit 23 and the mobile communication apparatus 3 for connection. Meanwhile, the password generating unit 26 generates data of a dynamic password to the mobile communication apparatus 3, so that once verification of the fingerprint and the dynamic password is successful, the flexible card body 1 is allowed to handshake with the mobile communication apparatus 3 by using the flexible electric control mechanism 2. Further, the mobile payment information in the mobile communication apparatus 3 is stored to the storage control unit 21, and the display unit 27 outputs a message of a storage status (for example, various light signals or text messages) to inform the card holder that the mobile payment information is currently being stored or has been stored. Thus, the mobile payment information in the mobile communication apparatus 3 can then be stored to the storage control unit 21.

To perform a transaction of the mobile payment information, the card holder may hold and place the flexible card body 1 in front of the transaction apparatus 4 of the merchant, and the card holder may contact the fingerprint receiving unit 24 by a finger (a finger with completed finger settings), so that the storage unit 21 performs, in coordination with the verification unit 25, recognition and verification of a fingerprint received by the fingerprint receiving unit 24. Upon confirming that the fingerprint belongs to the card holder, the display unit 27 outputs a confirmation message (for example, various light signals or text messages), and the storage control unit 21 is caused to activate the wireless connection unit 23 and the transaction apparatus 4 for connection. Meanwhile, the password generating unit 26 generates data of a dynamic password to the transaction apparatus 4, so that once verification of the fingerprint and the dynamic password is successful, the flexible electric control mechanism 2 is allowed to handshake with the transaction apparatus 4 and to make a payment by using the mobile payment information in the storage control unit 21. Moreover, the display unit 27 outputs a message of a transaction status (for example, various light signals of text messages) so as to inform the card holder that the transaction of the mobile payment information has completed. Thus, a transaction of a mobile payment can be directly performed by using the flexible electric control mechanism 2 in the flexible card body 1, preventing any transaction failure caused by power shortage or poor signals of the mobile communication apparatus 3 and eliminating the need of handing the mobile communication apparatus 3 or the flexible card body 1 to others, thereby achieving improved transaction security, ensuring personal privacy and enhancing ease of use of mobile payments.

On the other hand, when storage or a transaction of the mobile payment information is performed, if the storage control unit 21 confirms, in coordination with the verification unit 25, that the fingerprint in the fingerprint receiving unit 24 does not belong to the card holder, the storage control unit 21 issues, in coordination with the verification unit 25, an error message. Moreover, the display unit 27 automatically outputs the error message (for example, various light signals or text messages), so that the storage control unit 21 does not operate at all in response or the storage control unit 21 is inactivated, hence achieving transaction security.

In one embodiment of the present disclosure, the display unit 27 further includes a light emitting module 271. The light emitting module 271 may coordinate with the display unit 27 to display a prompt during use, and may be a light emitting diode (LED). During use, display modes, such as constantly on, glittering, cyclically emitting light or changing colors of light, of the light emitting module 271 may be pre-set in the storage control unit 21. When the display unit 27 outputs a message of a storage status, a message of a transaction status or an error message, a corresponding light signal message may be output in coordination with the light emitting module 271, so as to enhance a prompting effect and adapt to requirements of different display statuses of use.

In addition to the embodiments above, in one embodiment of the present disclosure, the display unit 27 includes a circuit backboard 272, a display module 273, an adhesive layer 274 and a protection outer layer 275. The circuit backboard 272 may be combined at the flexible card body 1, and has a loop groove 276. The display module 273 is disposed on one surface of the circuit backboard 272, such that the loop groove 276 is located on a periphery of the display module 273. The adhesive layer 274 is disposed at the loop groove 276. The protection outer layer 275 covers the display module 273. Thus, the adhesive layer 274 can be accommodated in the loop groove 276 to prevent overflowing of adhesive, and securing and protection of the display module 273 are achieved by the adhesive layer 274 in coordination with the protection outer layer 275, hence providing the display unit 27 with better flexibility and appearance as well as maintaining the quality of display.

In one embodiment of the present disclosure, an input switch 28 is further included. The input switch 28 is disposed at the flexible card body 1 and is electrically connected to the storage control unit 21. The input switch 28 may be a spring sheet switch, a resistive touch switch, a capacitive touch switch or a fingerprint switch. In addition to activating the storage control unit 21 and the fingerprint receiving unit 24 for control of fingerprint recognition once powered on, the input switch 28 may further be used for associated setting of use of the storage control unit 21, thereby adapting to different statuses of use and manufacturing requirements.

The present invention is described by way of the preferred embodiments above. A person skilled in the art should understand that, these embodiments are merely for describing the present invention are not to be construed as limitations to the scope of the present invention. It should be noted that all equivalent changes, replacements and substitutions made to the embodiments are to be encompassed within the scope of the present invention. Therefore, the scope of protection of the present invention should be accorded with the broadest interpretation of the appended claims.

What is claimed is:

1. A flexible card communicating with a mobile communication apparatus, the flexible card comprising:
a flexible card body; and
a flexible electric control mechanism, disposed at the flexible card body, the flexible electric control mechanism comprising:
a storage control unit, performing operation processing of the flexible electric control mechanism, and storing fingerprint data, personal data, mobile payment information and transaction data of a user;
a power unit, electrically connected to the storage control unit, the power unit for supplying power;
a wireless connection unit, electrically connected to the storage control unit, the wireless connection unit connected to the mobile communication apparatus to receive and store the mobile payment information to the storage control unit;
a fingerprint receiving unit, electrically connected to the storage control unit, the fingerprint receiving unit receiving fingerprint data of the user;
a verification unit, electrically connected to the storage control unit, the verification unit receiving and verifying the fingerprint data from the fingerprint receiving unit;
a password generating unit, electrically connected to the storage control unit, the password generating unit for generating password data to the mobile communication apparatus or a transaction apparatus; and
a display unit, electrically connected to the storage control unit, the display unit for displaying a prompt during use.

2. The flexible card communicating with a mobile communication apparatus according to claim 1, wherein the storage control unit is a central processor, a control chip or a logic circuit.

3. The flexible card communicating with a mobile communication apparatus according to claim 1, wherein the power unit is a secondary battery, a primary battery or a capacitor.

4. The flexible card communicating with a mobile communication apparatus according to claim 1, wherein the wireless connection unit is based on a BLUETOOTH communication protocol or an NFC communication protocol.

5. The flexible card communicating with a mobile communication apparatus according to claim 1, wherein the display unit comprises a circuit backboard, a display module, an adhesive layer and a protection outer layer; the circuit backboard has a loop groove, the display module is disposed on one surface of the circuit backboard such that the loop groove is located on a periphery of the display module, the adhesive layer is disposed at the loop groove, and the protection outer layer covers the display module.

6. The flexible card communicating with a mobile communication apparatus according to claim 1, wherein the display unit further comprises a light emitting module, which is capable of displaying the prompt during use in coordination with the display unit.

7. The flexible card communicating with a mobile communication apparatus according to claim 1, further comprising:
an input switch, disposed at the flexible card body and electrically connected to the storage control unit, the input switch being a spring sheet switch, a resistive touch switch, a capacitive touch switch or a fingerprint switch.
